(19) United States
(12) Patent Application Publication
(10) Pub. No.: US 2026/0149780 A1
(43) Pub. Date: May 28, 2026

(54) DOCUMENT READING APPARATUS FOR CORRECTING DATA OF READ IMAGE

(71) Applicant: CANON KABUSHIKI KAISHA, Tokyo (JP)

(72) Inventor: SATOSHI OKAWA, Ibaraki (JP)

(21) Appl. No.: 19/398,157

(22) Filed: Nov. 24, 2025

(30) Foreign Application Priority Data
Nov. 26, 2024 (JP) 2024-205697

(51) Int. Cl. H04N 1/00

(52) U.S. Cl. CPC H04N 1/00822; H04N 1/00811; H04N 2201/0081

(57) ABSTRACT

A document reading apparatus, includes: a control unit configured to determine one reading mode among a plurality of reading modes based on input of an instruction for starting reading, cause a reading unit to read an image of a document in accordance with the one reading mode while conveying the document, and correct data of the image of the document read by the reading unit based on correction data for the one reading mode; and a setting unit configured to set a plurality of candidate reading modes selected from the plurality of reading modes as candidates for the one reading mode, wherein the control unit is configured to start generation processing for generating correction data for each of the plurality of candidate reading modes when the setting unit sets the plurality of candidate reading modes.

### BACKGROUND

### Field of the Technology

The present disclosure relates to a document reading apparatus that reads an image of a document.

### Description of the Related Art

Document reading apparatuses include a reading unit that optically reads an image of a conveyed document (hereinafter, referred to as a document image). As an example, the reading unit includes a line sensor that reads an image of one line in a main scanning direction. A document reading apparatus, by repeatedly reading images of single lines of a document placed on a document platen glass by the reading unit while moving the reading unit in a sub-scanning direction orthogonal to the main scanning direction, reads a document image. In addition, document reading apparatuses that include an Auto Document Feeder (ADF), by repeatedly reading images of single lines of a document conveyed in the sub-scanning direction (conveyance direction) by the reading unit, read a document image. In the following description, the reading of the document image while the document is being conveyed is also referred to as “flow reading”. In document reading apparatuses, it is important to shorten the period from when an instruction to start reading is inputted until when the image data of the document image is outputted, that is, the First Copy Output Time (FCOT).

In reading a document image, the document reading apparatus performs shading correction for correcting differences in the amount of light at each position of the document in the main scanning direction and differences in the sensitivity of each pixel of the line sensor. The correction data used in the shading correction is generated by reading a white reference plate provided in the document reading apparatus. In the following description, correction data used in shading correction is also simply referred to as “correction data”, and processing for generating correction data is also simply referred to as “generation processing”. Japanese Patent Laid-Open No. 2011-023990 discloses performing generation processing when an apparatus is powered on.

A document reading apparatus is configured to be able to read document images at various resolutions. The correction data to be used when the document reading apparatus reads a document at a certain resolution needs to be generated by reading the reference plate at that resolution. That is, the correction data is associated with the reading resolution of the document, and the document reading apparatus uses the correction data of the resolution for that reading (correction data associated with that resolution) in the shading correction at the time of reading the document.

Therefore, in a case where the resolution associated with the correction data generated when the power is turned on is different from the resolution designated at the time of reading, the document reading apparatus needs to perform generation processing for generating correction data of the designated resolution before reading the document. In this case, the FCOT becomes longer. Accordingly, U.S. Pat. No. 10,999,461 discloses a configuration in which generation processing is executed triggered by a user changing a resolution setting.

### SUMMARY

The present disclosure provides a technique for preventing the FCOT from becoming longer.

According to an aspect of the present disclosure, a document reading apparatus, includes: a tray on which a document is placed; a reading unit configured to read an image of the document; a reference member; a control unit configured to determine one reading mode among a plurality of reading modes based on input of an instruction for starting reading, cause the reading unit to read the image of the document placed on the tray in accordance with the one reading mode while conveying the document, and correct data of the image of the document read by the reading unit based on correction data for the one reading mode; and a setting unit configured to set a plurality of candidate reading modes selected from the plurality of reading modes as candidates for the one reading mode, wherein the control unit is configured to start generation processing for generating correction data for each of the plurality of candidate reading modes when the setting unit sets the plurality of candidate reading modes.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic cross-sectional view of a document reading apparatus.

FIG. 2 is a block diagram illustrating a control configuration of the document reading apparatus.

FIGS. 3A to 3D are diagrams illustrating exemplary light emission sequences of a light source.

FIGS. 4A to 4C are explanatory diagrams of correction data.

FIGS. 5A to 5C are diagrams illustrating examples of screens displayed on the operation unit.

FIG. 6 is a diagram illustrating an example of a relationship between processing content and reading modes.

FIG. 7 is a flowchart of processing executed by the reading control unit.

FIG. 8 is a flowchart of generation processing.

FIG. 9 is a detailed flowchart of the generation processing.

FIG. 10 is a flowchart of processing performed by the reading control unit in parallel with the generation processing.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### First Embodiment

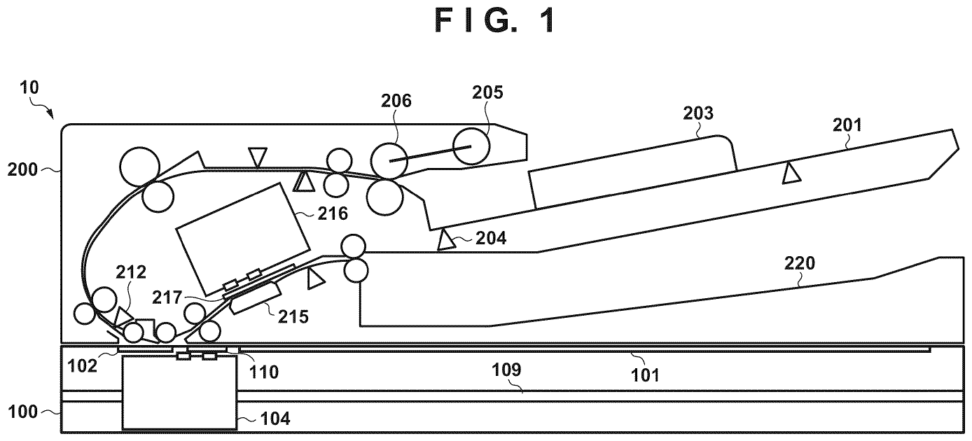

FIG. 1 is a schematic cross-sectional view of a document reading apparatus 10 according to the present embodiment. The document reading apparatus 10 includes a reader 100 that generates document image data by reading a document, and an ADF 200 that feeds the document to the reader 100. The document reading apparatus 10 may transmit the generated image data to a personal computer (PC) via a network (scan processing). The document reading apparatus 10 of the present embodiment is further configured to output the generated image data to a facsimile machine (FAX) function unit (not illustrated) so that facsimile transmission can be performed (FAX processing). Further, the document reading apparatus 10 of the present embodiment is configured to be able to form a document image on a sheet by outputting the generated image data to an image forming unit (not illustrated) (copy processing).

Documents to be read are stacked on a document tray 201. A detection sensor 204 detects whether or not documents are stacked on the document tray 201. A guide plate 203 regulates the position of the documents stacked on the document tray 201 in the width direction. The width direction is a direction orthogonal to the conveyance direction of the document, and corresponds to the main scanning direction. The conveyance direction corresponds to the sub-scanning direction.

A pickup roller 205 feeds the uppermost document among one or more documents placed on the document tray 201 to the conveyance path of the document reading apparatus 10. A separation roller pair 206 is provided to prevent double feeding of documents. The document reading apparatus 10 includes a plurality of rollers for conveying a document along a conveyance path. A reading unit 104 optically reads the document image of a first surface of the document conveyed on the conveyance path via a glass 102. A reading unit 216 optically reads the document image of a second surface of the document conveyed on the conveyance path via a glass 217. The reading unit 104 and the reading unit 216 each include a light source that is capable of emitting red (R), green (G), and blue (B) light, such as, for example, a light-emitting diode (LED). The reading unit 104 and the reading unit 216 each have a line sensor that receives light emitted from the light source and reflected by the document. The line sensor includes a plurality of light receiving elements (pixels) provided along the main scanning direction.

After the document image of the second surface of the document has been read by the reading unit 216, the document is discharged to a discharge tray 220. A lead sensor 212 detects a conveyed document. The detection timing of the document by the lead sensor 212 is used to determine the timing at which the document is to be read by the reading unit 104 and the reading unit 216. A white reference plate 110 is a reference member used to generate correction data used in shading correction when reading by the reading unit 104. A white reference plate 215 is a reference member used to generate correction data used in shading correction when reading by the reading unit 216.

The reading unit 104 is configured to be movable in the left-right direction in the drawing along a movement guide 109 in order to read an image of a document placed on a document platen glass 101. The position at which the reading unit 104 reads the conveyed document may be different from the position at which the reading unit 104 reads the reference plate 110. In a case where the position at which the reading unit 104 reads the document being conveyed is different from the position at which the reading unit 104 reads the reference plate 110, the reading unit 104 is moved to the position at which the reference plate 110 is to be read when the reference plate 110 is read.

The document reading apparatus can be configured to be capable of executing both processing for reading a document image in color and outputting color image data, and processing for reading a document image in monochrome and outputting monochrome image data. In the following description, the operation of reading the document image in color is also referred to as a “color reading operation”, and the operation of reading the document image in monochrome is also referred to as a “monochrome reading operation”. The color reading operation and the monochrome reading operation are also collectively referred to as “reading operations”.

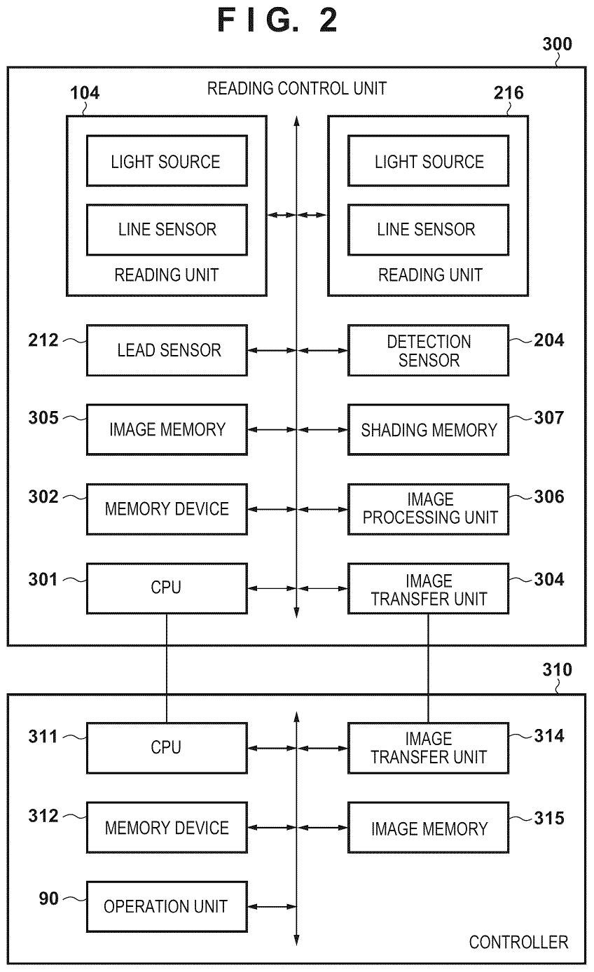

FIG. 2 is a block diagram illustrating a control configuration of the document reading apparatus 10. A controller 310 controls the entire document reading apparatus 10 including a FAX function unit (not illustrated) and an image forming unit. A reading control unit 300 controls the ADF 200 and the reader 100 under the control of the controller 310.

A CPU 301 of the reading control unit 300 controls the ADF 200 and the reader 100 by executing programs stored in a memory device 302. The memory device 302 includes a volatile memory device and a non-volatile memory device. The memory device 302 stores programs to be executed by the CPU 301, and various kinds of information used for controlling the ADF 200 and the reader 100. An image memory 305 is used to temporarily store image data to be read by the reading unit 104 and the reading unit 216. An image processing unit 306 performs various types of image processing including shading correction on the image data stored in the image memory 305. Note that the image processing unit 306 performs shading correction using the correction data stored in a shading memory 307. An image transfer unit 304 transmits the image data after the image processing by the image processing unit 306 to an image transfer unit 314 of the controller 310.

A CPU 311 of the controller 310 controls the entirety of the document reading apparatus 10 by executing programs stored in a memory device 312. The memory device 312 includes a volatile memory device and a non-volatile memory device. The memory device 312 stores programs to be executed by the CPU 311, and various types of information used for controlling the document reading apparatus 10. The image transfer unit 314 stores the image data received from the image transfer unit 304 in an image memory 315. An operation unit 90 provides a user interface for a user to operate the document reading apparatus 10. The CPU 311 transmits and receives various control commands and control data to and from the CPU 301 for the control of the reading control unit 300.

For example, when the user inputs an instruction to start reading a document via the operation unit 90, the CPU 311 transmits a reading start request to the CPU 301. The CPU 301 controls reading of a document in response to a reading start request from the CPU 311. The CPU 301 notifies the CPU 311 of the progress status of the document reading control, and the CPU 311 displays the progress status and the like on the operation unit 90.

The CPU 301 causes the reading unit 104 to read the reference plate 110 to generate correction data used in shading correction for the image data read by the reading unit 104, that is, correction data for the reading unit 104. Also, the CPU 301 causes the reading unit 216 to read the reference plate 215, thereby generating correction data used in shading correction for the image data read by the reading unit 216, that is, correction data for the reading unit 216. Since the method of generating the correction data for the reading unit 104 and the method of generating the correction data for the reading unit 216 are the same, a method of generating the correction data for the reading unit 104 will be representatively described below, and description of the reading unit 216 will be omitted.

In the present embodiment, the document reading apparatus 10 has four reading modes. The reading mode is specified by a combination of resolution and reading operation. A reading mode #C1 is a mode in which a color reading operation is performed with the resolution in the main scanning direction and the resolution in the sub-scanning direction as 300 DPI and 600 DPI, respectively. A reading mode #C2 is a mode in which a color reading operation is performed with the resolution in the main scanning direction and the resolution in the sub-scanning direction as 300 DPI and 300 DPI, respectively. A reading mode #M1 is a mode in which a monochrome reading operation is performed with the resolution in the main scanning direction and the resolution in the sub-scanning direction as 600 DPI and 600 DPI, respectively. A reading mode #M2 is a mode in which a monochrome reading operation is performed with the resolution in the main scanning direction and the resolution in the sub-scanning direction as 300 DPI and 600 DPI, respectively. In the following explanation, the reading mode #C1 and the reading mode #C2 are collectively referred to as the “reading mode #C”. Also, the reading mode #M1 and the reading mode #M2 are collectively referred to as the “reading mode #M”. The reading mode #C is a mode in which a color reading operation is performed, and the reading mode #M is a mode in which a monochrome reading operation is performed.

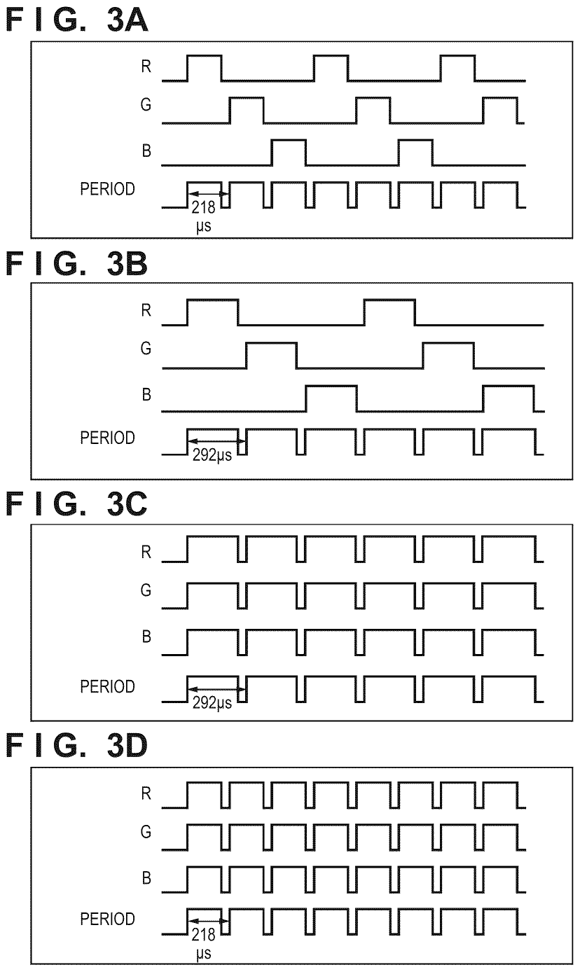

FIG. 3A illustrates light emission timings of a light source of the reading unit 104 in the reading mode #C1. FIG. 3B illustrates light emission timings of the light source of the reading unit 104 in the reading mode #C2. FIG. 3C illustrates light emission timings of the light source of the reading unit 104 in the reading mode #M1. FIG. 3D illustrates light emission timings of the light source of the reading unit 104 in the reading mode #M2.

In the case of the color reading operation, the light source of the reading unit 104 is caused to emit light in the order of red, green, and blue in order to obtain the respective luminance levels of red, green, and blue. On the other hand, in the case of the monochrome reading operation, the light source is caused to emit light in red, green, and blue simultaneously. That is, in the case of the monochrome reading operation, the light source is caused to emit white light. Further, in both the color reading operation and the monochrome reading operation, if the resolution is different, the light emission period of the light source is different.

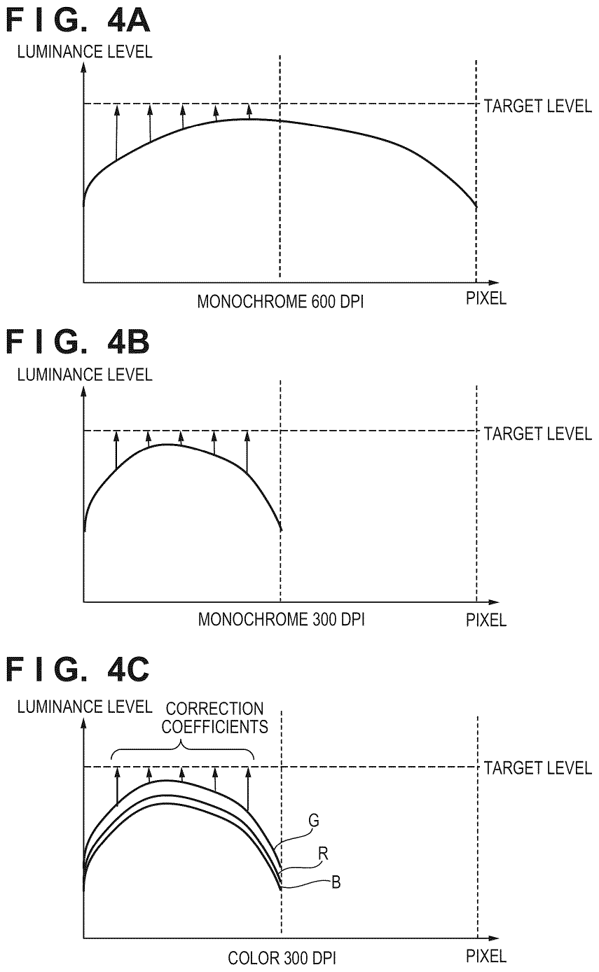

FIG. 4A illustrates the result of reading the reference plate 110 in the reading mode #M1, and more specifically, the luminance level detected by the pixels arranged along the main scanning direction of the line sensor. Ideally, the luminance levels detected by the respective pixels of the line sensor when the reference plate 110 is read would be the same, but in practice, they are not the same due to differences in the amount of irradiated light across positions in the main scanning direction or differences in the sensitivities of the respective pixels of the line sensor. The correction data is data indicating a correction coefficient of each pixel for setting to a target level a luminance level detected by each pixel of the line sensor when the reference plate 110 is read. In FIG. 4A, the arrows correspond to the correction coefficients. The correction data is composed of data corresponding to the number of pixels in the main scanning direction for each color of light emitted from the light source.

FIG. 4B illustrates the result of reading the reference plate 110 in the reading mode #M2. In the reading mode #M2, the number of pixels in the main scanning direction is ½ that of the reading mode #M1. As illustrated in FIG. 4A and FIG. 4B, since the relationship between the respective pixels and the correction coefficients differs depending on the resolution in the main scanning direction, the correction data needs to be generated for each resolution. FIG. 4C illustrates the result of reading when the reference plate 110 is read in the reading mode #C2. As illustrated in FIG. 4C, in the case of the color reading operation, the correction coefficients need to be calculated for each of R, G, and B. Therefore, even if the resolutions are the same, the correction data used in the color reading operation and the correction data used in the monochrome reading operation are different from each other. In summary, the correction data needs to be generated for each combination of resolution and reading operation, that is, for each reading mode.

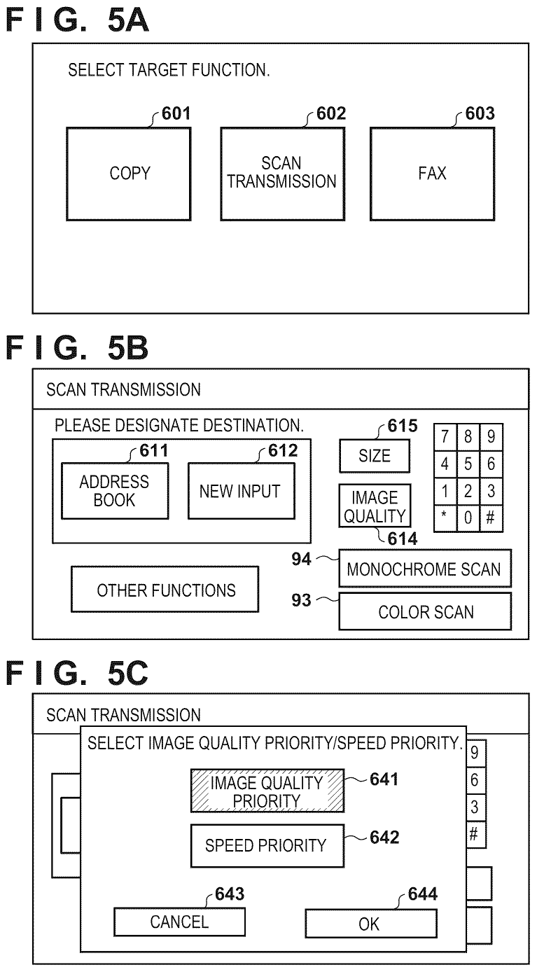

FIGS. 5A to 5C are diagrams illustrating examples of screens displayed on the operation unit 90. FIG. 5A is, for example, a top screen displayed after the document reading apparatus 10 is activated. When a copy button 601 is pressed, the CPU 311 displays on the operation unit 90 a setting screen for copy processing for forming a document image on the sheet by transmitting image data of the document image to an image forming unit (not illustrated). When a FAX button 603 is pressed, the CPU 311 displays on the operation unit 90 a setting screen for FAX processing for transmitting the image data of the document image by FAX. When a scan transmission button 602 is pressed, the CPU 311 displays on the operation unit 90 a setting screen for scan processing for transmitting the image data of the document image to a PC.

FIG. 5B illustrates an example of a screen displayed on the operation unit 90 when the scan transmission button 602 is pressed. When an address book button 611 is pressed, the CPU 311 displays on the operation unit 90 a screen for selecting a PC as the destination of the image data. When a new input button 612 is pressed, the CPU 311 displays on the operation unit 90 a screen for registering a PC as the destination of the image data. When a size button 615 is pressed, the CPU 311 displays on the operation unit 90 a screen for designating the size of the document. When an image quality button 614 is pressed, the CPU 311 displays on the operation unit 90 a screen for selecting the image quality of the document image.

When a color scan button 93 is pressed, the CPU 311 transmits a request to start document reading in the reading mode #C to the CPU 301. Which one of the reading mode #C1 and #C2 is used depends on an image quality setting to be described later. When a monochrome scan button 94 is pressed, the CPU 311 transmits a request to start document reading in the reading mode #M to the CPU 301. Also, which one of the reading mode #M1 and reading mode #M2 is used depends on the image quality setting to be described later.

FIG. 5C illustrates an example of a screen displayed on the operation unit 90 when the image quality button 614 is pressed. Configuration is such that only one of an image quality priority button 641 and a speed priority button 642 can be selected. In the following description, the image quality priority button 641 and the speed priority button 642 are collectively referred to as the “priority buttons”. When the image quality priority button 641 is selected, the CPU 311 uses the higher resolution reading mode of the two reading modes of the same reading operation. On the other hand, when the speed priority button 642 is selected, the CPU 311 uses the lower resolution reading mode of the two reading modes of the same reading operation.

Therefore, when the color scan button 93 is pressed after the image quality priority button 641 is selected, the CPU 311 transmits a request to start document reading in the reading mode #C1 to the CPU 301. Also, when the monochrome scan button 94 is pressed after the image quality priority button 641 is selected, the CPU 311 transmits a request to start document reading in the reading mode #M1 to the CPU 301. Furthermore, when the color scan button 93 is pressed after the speed priority button 642 is selected, the CPU 311 transmits a request to start document reading in the reading mode #C2 to the CPU 301. Furthermore, when the monochrome scan button 94 is pressed after the speed priority button 642 is selected, the CPU 311 transmits a request to start document reading in the reading mode #M2 to the CPU 301.

When an OK button 644 is pressed, the CPU 311 allows confirmation of the priority button selection result and displays on the operation unit 90 the screen of FIG. 5B. When a cancel button 643 is pressed, the CPU 311 cancels the priority button selection result and displays on the operation unit 90 the screen of FIG. 5B. In this case, the previous selection result is maintained.

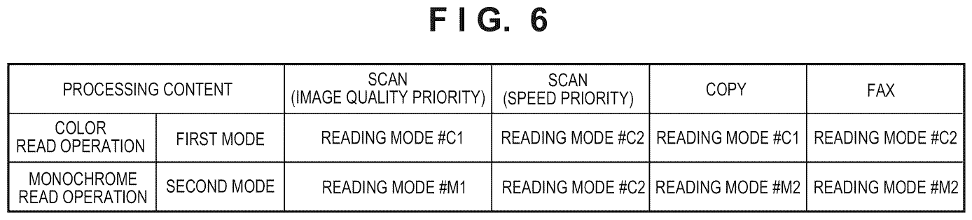

As described above, and as illustrated in FIG. 6, in a case where image quality priority in scan processing is selected, the document reading apparatus 10 reads the document at higher quality, that is, in the reading mode #C1 or the reading mode #M1. Also, in a case where speed priority in scan processing is selected, the document reading apparatus 10 reads the document at lower quality, that is, in the reading mode #C2 or the reading mode #M2. As illustrated in FIG. 6, the document reading apparatus 10 reads a document in the reading mode #C1 in the case of color copy processing, and reads a document in the reading mode #M2 in the case of monochrome copy processing. Furthermore, as illustrated in FIG. 6, the document reading apparatus 10 reads a document in the reading mode #C2 in the case of color FAX processing, and reads a document in the reading mode #M2 in the case of the monochrome FAX processing.

In the following explanation, “scan (image quality priority)”, “scan (speed priority)”, “copy”, and “FAX” illustrated in FIG. 6 are referred to as “processing content” of the document reading apparatus 10. As illustrated in FIG. 6, one reading mode in the color reading operation and one reading mode in the monochrome reading operation are determined according to the selected processing content. Hereinafter, the one reading mode in the color reading operation and one reading mode in the monochrome reading operation determined according to the selected processing content are referred to as a “first mode” and a “second mode”. For example, when “scan (image quality priority)” is selected as the processing content, the first mode is the reading mode #C1 and the second mode is the reading mode #M1. The first mode and the second mode are reading modes that are highly likely to be actually used for reading a document in an instruction to start reading thereafter, and are also referred to as “candidate reading modes”.

The CPU 311 is configured to notify the CPU 301 of the first mode and the second mode determined by the changed processing content in a case where the processing content has changed. Note that the CPU 311 may be configured to notify the CPU 301 of the first mode and the second mode determined by default processing content when the document reading apparatus 10 is activated. In the case of the scan processing, whether or not the content of the processing has been changed is determined when the user presses the OK button 644 on the screen of FIG. 5C. More specifically, when the user selects a priority button that is not the one that was selected until then and presses the OK button 644, the CPU 311 determines that the processing content has been changed. Meanwhile, when the user selects the same priority button as was selected until then and presses the OK button 644, the CPU 311 determines that the processing content has not been changed. Although not illustrated, similarly to the copy processing and FAX processing, the CPU 311 determines whether or not the processing content has been changed when the user performs a predetermined operation on the operation unit 90. The CPU 311 transmits, to the CPU 301, a request to start document reading where the reading mode is designated, when a button indicating the start of reading of a document is pressed. In the case of the scan processing, the buttons indicating the start of document reading are the monochrome scan button 94 and the color scan button 93 illustrated in FIG. 5B. Although not illustrated, the operation unit 90 also displays a button indicating the start of document reading, as with the copy processing and the FAX processing.

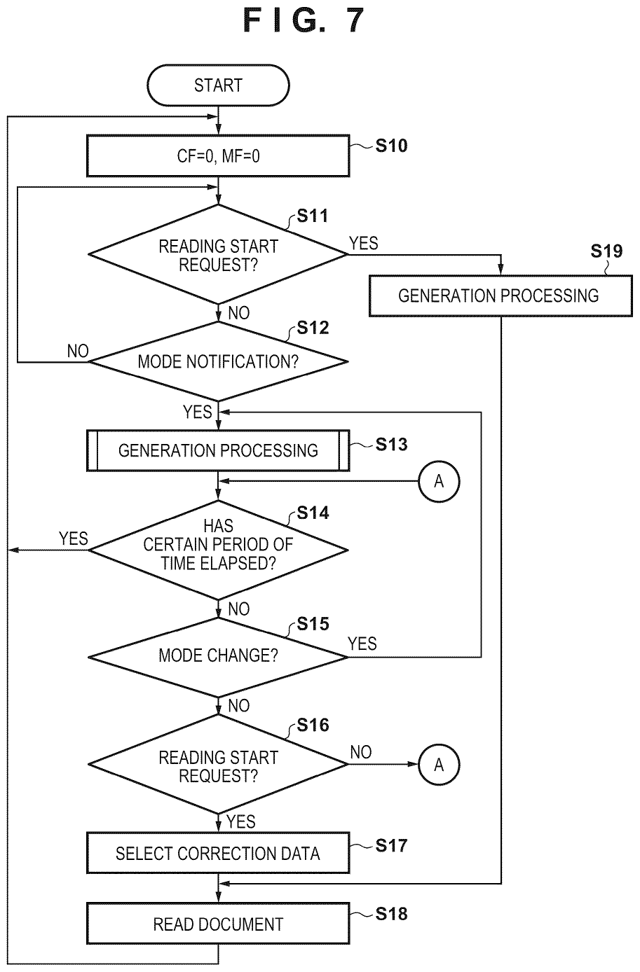

FIG. 7 is a flowchart of processing executed by the reading control unit 300. The CPU 301 sets both the two flags CF and MF to 0 in step S10. When the flag CF is 0, it indicates that the correction data of the first mode has not been generated. When the flag MF is 0, it indicates that the correction data of the second mode has not been generated. In step S11, the CPU 301 determines whether a reading start request has been received from the CPU 311. In a case where the reading start request has been received in step S11, the CPU 301 performs generation processing for generating the correction data for the operation mode specified by the reading start request in step S19. Then, the CPU 301 reads the document in step S18. At this time, the shading correction is performed using the correction data generated in step S19. In a case where a reading start request is received when a document is not placed on the document tray 201, the CPU 301 notifies the CPU 311 that a document has not been placed, and the determination of step S11 is “No”. After the document is read in step S18, the CPU 301 repeats the processing from step S10.

In step S11, in a case where the reading start request has not been received, the CPU 301 determines whether the first mode and the second mode are notified by the CPU 311 in step S12. In a case where the CPU 311 has not notified the first mode and the second mode, the CPU 301 repeats the processing from step S11. In a case where the CPU 311 has notified the first mode and the second mode, the CPU 301 starts generation processing for generating the correction data in step S13. Note that configuration may be taken such that the processing for generating the correction data in step S13 is started only in a case where a document has been placed on the document tray 201, and the determination of step S12 may be treated as “No” in a case where a document has not been placed on the document tray 201.

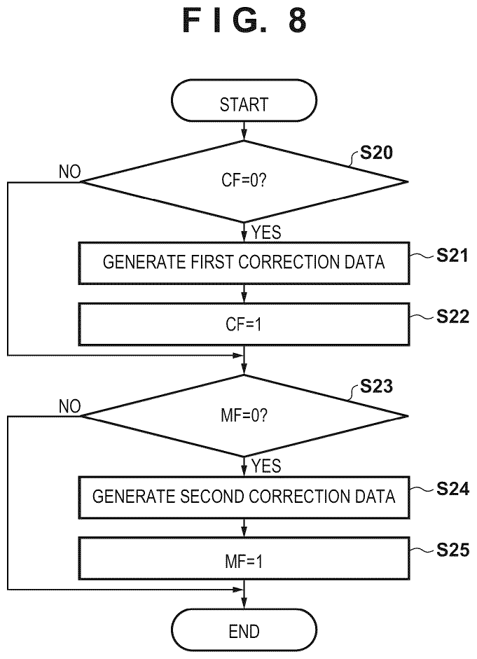

FIG. 8 is a flowchart for the processing for generating correction data in step S13. In step S20, the CPU 301 determines whether CF is 0. In a case where CF is 0, the CPU 301 reads the reference plate 110 in the first mode in step S21 to generate correction data (hereinafter, first correction data) in the first mode. The generated first correction data is stored in the shading memory 307, and the CPU 301 stores the first correction data in the memory device 302. Thereafter, the CPU 301 sets CF to a value other than 0 in step S22; to 1 in the present example. In a case where CF differs from 0 in step S20, the CPU 301 skips the processing of step S21 and step S22.

After that, in step S23, the CPU 301 determines whether MF is 0. In a case where MF is 0, the CPU 301 reads the reference plate 110 in the second mode in step S24 to generate correction data (hereinafter, second correction data) in the second mode. The generated second correction data is stored in the shading memory 307. Thereafter, the CPU 301 sets MF to a value other than 0 in step S25; to 1 in the present example. In a case where MF differs from 0 in step S23, the CPU 301 skips the processing of step S24 and step S25.

Since both CF and MF are set to 0 in step S10, both the first correction data and the second correction data are generated in step S13. In the description of FIG. 8, the second correction data is not stored in the memory device 302, but a configuration may be taken in which the second correction data is also stored in the memory device 302. Also, in the present embodiment, since it is not possible to store both the first correction data and the second correction data in the shading memory 307, one of the correction data is stored in the memory device 302. However, in a case where both the first correction data and the second correction data can be stored in the shading memory 307, both may be stored in the shading memory 307. Further, in the present embodiment, the first correction data is generated first, but configuration may be taken such that the second correction data is generated first.

Returning to FIG. 7, in step S14, the CPU 301 transitions to a state of waiting to receive a reading start request from the CPU 311. In a case where the CPU 301 does not receive a reading start request from the CPU 311 even after a certain period of time has elapsed, it discards the first correction data and the second correction data generated in step S13 and repeats the processing from step S10. In step S14, in a case where the certain period of time has not elapsed, the CPU 301 determines, in step S15, whether a notification of a change in at least one of the first mode and the second mode has been received from the CPU 311. In a case where both the first mode and the second mode have not been changed, the CPU 301 determines in step S16 whether a reading start request has been received from the CPU 311. In a case where a reading start request has not been received in step S16, the CPU 301 repeats the processing from step S14.

In a case where a reading start request has been received in step S16, the CPU 301 selects the correction data in step S17. Specifically, in a case where the color reading operation is designated from the CPU 311, the first correction data generated in step S13 is selected, and in a case where the monochrome reading operation is designated, the second correction data generated in step S13 is selected. In a case where the selected correction data is not stored in the shading memory 307, the CPU 301 reads the selected correction data from the memory device 302 and stores the selected correction data in the shading memory 307. Then, the CPU 301 reads the document in step S18. At that time, the image processing unit 306 performs shading correction using the correction data stored in the shading memory 307. After the document is read in step S18, the CPU 301 repeats the processing from step S10.

Meanwhile, in step S15, in a case where the notification of a change in at least one of the first mode and the second mode is received from the CPU 311, the CPU 301 sets the flag of the changed mode to 0 and repeats the processing from step S13. That is, the CPU 301 sets CF to 0 in a case where the first mode is changed, sets MF to 0 in a case where the second mode is changed, and sets both CF and MF to 0 in a case where both the first mode and the second mode are changed. Therefore, in the generation processing of step S13 performed upon a change in the first mode and/or the second mode, only the correction data for the changed mode, that is, only the correction data that has not been generated is generated.

As described above, for each of the color reading operation and the monochrome reading operation, correction data of the selected resolution is generated before an instruction to start reading is inputted as correction candidate data. When it is determined which of the color reading operation and the monochrome reading operation is to be performed upon input of an instruction to start reading, shading correction is performed using the correction candidate data of the determined reading operation as correction data. With this configuration, the FCOT can be shortened.

In the sequence of FIG. 7, after the generation processing (step S13), in a case where the reading start request is not received even after a certain period of time has elapsed, the CPU 301 discards the first correction data and the second correction data and repeats the processing from step S10. However, configuration may be taken such that the first correction data generated in the generation processing is maintained as long as the first mode is not changed, and the second correction data generated in the generation processing is maintained as long as the second mode is not changed.

### Second Embodiment

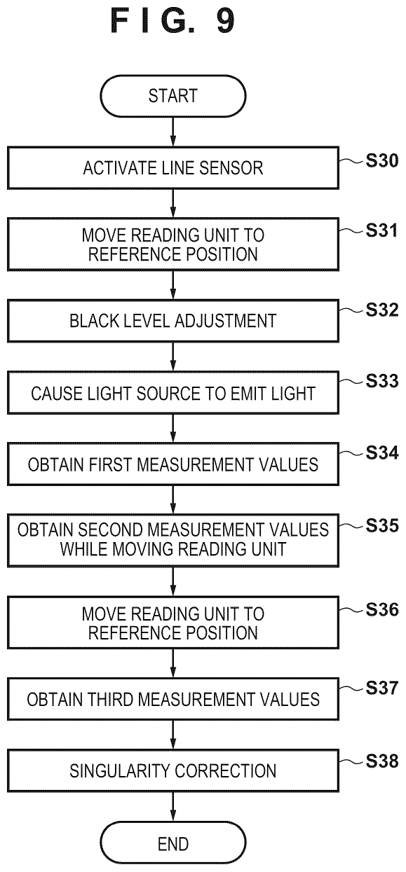

Next, a second embodiment will be described with a focus on differences from the first embodiment. In the generation processing executed in step S13 of FIG. 7, in a case where both CF and MF are 0, the CPU 301 needs to generate both the first correction data and the second correction data. Here, details of the processing for generating one piece of correction data will be described with reference to FIG. 9.

First, in step S30, the CPU 301 sets the line sensor of the reading unit 104 to be activated, that is, operable. The CPU 301 moves the reading unit 104 to a reference position for reading the reference plate 110 in step S31. The CPU 301 performs black level adjustment in step S32 by measuring with a line sensor without causing the light source to emit light. The CPU 301 causes the light source of the reading unit 104 to emit light in step S33. The CPU 301 acquires first measured values (first measurement values) by measuring the reference plate 110 in step S34. The CPU 301 determines thresholds for extracting singularities indicative of fouling of the reference plate 110 based on the first measurement values. The CPU 301 acquires second measured values (second measurement values) by measuring the reference plate 110 while moving the reading unit 104 within a range in which the reference plate 110 can be measured in step S35. The CPU 301 extracts singularities based on the second measurement values to determine correction coefficients. The CPU 301 causes the reading unit 104 to move to the reference position again in step S36. The CPU 301 acquires third measurement values (third measurement values) by measuring the reference plate 110 at the reference position in step S37. The third measurement values are used to generate the correction data. In step S38, the CPU 301 performs singularity correction using correction coefficients determined based on the second measurement values to generate correction data.

In a case where the color scan button 93 is pressed during the generation of the second correction data (during the execution of step S24 in FIG. 8) in the generation processing of step S13 in FIG. 7 for example, the FCOT can be shortened by ending the generation processing without waiting for the completion of the generation of the second correction data, and starting the document reading in step S18. Similarly, in a case where the monochrome scan button 94 is pressed while the first correction data is being generated (during execution of step S21 in FIG. 8), the FCOT can be shortened by starting the generation of the second correction data without completing the generation of the first correction data.

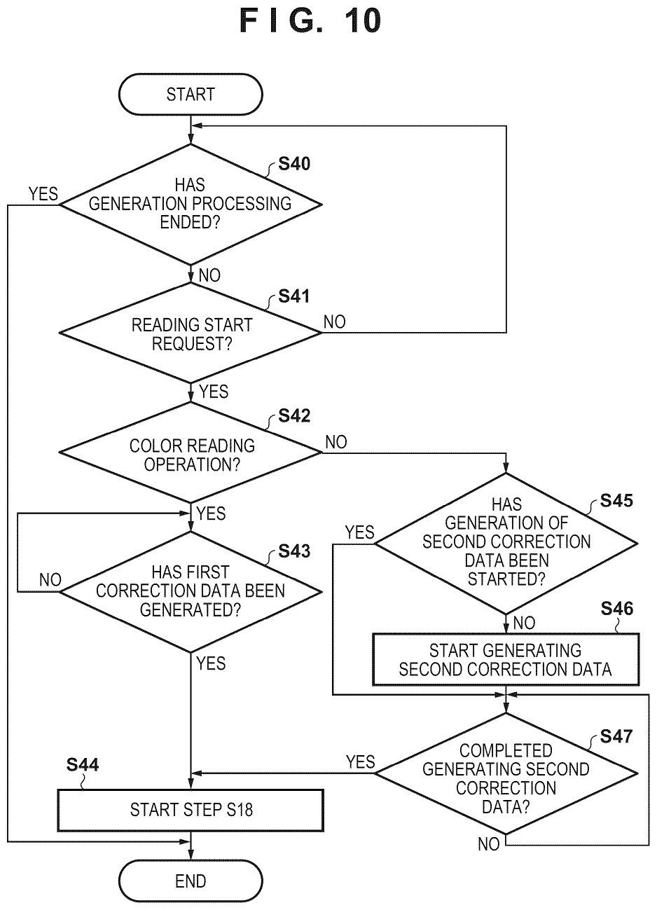

In the present embodiment, in step S13 of FIG. 7, the processing described in FIG. 10 is performed while the generation processing illustrated in FIG. 8 is executed. In step S40, the CPU 301 determines whether the generation processing has ended. In a case where the generation processing has ended, the CPU 301 ends the processing of FIG. 10. In a case where the generation processing has not ended, the CPU 301 determines, in step S41, whether a reading start request has been received from the CPU 311. Note that, for example, configuration may be taken such that the timing of the determination of step S41 is at each of step S30 to step S38 of FIG. 9. In a case where a reading start request has not been received, the CPU 301 repeats the processing from step S40. In a case where the reading start request has been received, the CPU 301 determines, in step S42, which of the color reading operation and a monochrome reading operation is to be performed.

In the case of the color reading operation, the CPU 301 determines in step S43 whether the first correction data has been generated, and thus the processing of step S24 of FIG. 8 is being executed. In a case where first correction data has already been generated, the CPU 301 ends the generation processing in step S44 without waiting for completion of the processing of step S24, and starts the processing of step S18 in FIG. 8, that is, reading of the document. On the other hand, in step S43, the fact that first correction data has not been generated means that the processing of step S21 of FIG. 8 is being executed. In step S43, in a case where the first correction data has not been generated, the CPU 301 waits until the generation of the first correction data has been completed, and when the generation of the first correction data has been completed, the generation processing is terminated without performing the processing for generating the second correction data, and the processing of step S44 is performed.

In the case of the monochrome reading operation in step S42, the CPU 301 determines in step S45 whether generation of the second correction data has already been started, in other words whether the processing of step S24 of FIG. 8 is being executed. The fact that the generation of the second correction data is not started means that the processing of step S21 of FIG. 8 is being executed. In a case where the generation of the second correction data has not been started, the CPU 301 does not wait for the completion of the processing of step S21 but rather stops it, and starts processing for generating the second correction data in step S46. The CPU 301 waits until the generation of the second correction data has been completed in step S47, and advances the processing to step S44 when the generation of the second correction data has been completed.

As described above, according to the present embodiment, in a case where a read start request has been inputted by the user during the generation processing, it is possible to shorten the FCOT by not generating unnecessary correction data among the first correction data and the second correction data.

### Third Embodiment

Next, a third embodiment will be described with a focus on differences from the first embodiment and the second embodiment. In the present embodiment, it is assumed that only one among the first correction data and the second correction data can be stored in the shading memory 307. Therefore, the CPU 301 stores only one of the first correction data and the second correction data, which is generated in advance, in the shading memory 307, and stores the other in the memory device 302. For example, when the second correction data is stored in the shading memory 307 and a reading start request for a color reading operation is received, the CPU 301 needs to read the first correction data stored in the memory device 302 and store the first correction data in the shading memory 307. In the present embodiment, the FCOT is shortened by reducing the frequency of the processing for storing the correction data stored in the memory device 302 in the shading memory 307 when the reading start request is received.

In the present embodiment, the CPU 301 determines which of the first correction data and the second correction data is to be stored in the shading memory 307 based on the history of the reading mode used in reading documents. For example, the CPU 301 records the reading mode of the previous reading of a document in the memory device 302. In the following description, the reading mode of the last reading of a document is referred to as a “reference reading mode”. In a case where the reference reading mode is the same as either of the first mode and the second mode notified by the CPU 311, the CPU 301 stores whichever of the first mode and the second mode is the same as the reference reading mode in the shading memory 307, and stores the other in the memory device 302. For example, if the first mode is the reading mode #C1, the second mode is the reading mode #M1, and the reference reading mode is the reading mode #C1, the CPU 301 stores the first correction data in the shading memory 307 and stores the other in the memory device 302.

In a case where the user continues to read documents in the same reading mode, the correction data for the same reading mode as the reference reading mode is stored in the shading memory 307, and thereby the FCOT can be shortened.

In a case where both the first mode and the second mode notified by the CPU 311 differ from the reference reading mode, the CPU 301 stores one of the first correction data and the second correction data in the shading memory 307 and stores the other in the memory device 302. As an example, in a case where the first correction data is generated first and then the second correction data is generated, the first correction data which is generated first is stored in the memory device 302, and the second correction data which is generated later is stored in the shading memory 307.

Also, configuration may be taken such that in a case where the reference reading mode is a mode in which a color reading operation is performed, the first correction data is stored in the shading memory 307, and in a case where the reference reading mode is a mode in which the monochrome reading operation is performed, the second correction data is stored in the shading memory 307. For example, in a case where a user consecutively performs color reading operations or consecutively performs monochrome reading operations but with different resolutions, the FCOT can be shortened by this configuration.

Further, as another example, the CPU 301 may record the reading modes for the reading of documents which was performed in a predetermined period of time in the past, determine the number of times each reading mode was set, and set the reading mode set the largest number of times as the reference reading mode.

According to the present embodiments described above, it is possible to reduce the frequency of processing for storing the correction data stored in the memory device 302 in the shading memory 307 when the reading start request is received. Accordingly, the FCOT can be shortened.

In each of the above-described embodiments, the reading mode is classified by a combination of two parameters—one for the reading resolution and one for the reading operation (color or monochrome)—but the reading mode can also be classified by a combination of three or more parameters. Further, in each of the above-described embodiments, two reading modes are selected as candidate reading modes, and correction data of each of the candidate reading modes is generated in advance. However, it is also possible to adopt a configuration in which three or more reading modes are selected as candidate reading modes.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-205697, filed Nov. 26, 2024, which is hereby incorporated by reference herein in its entirety.

What is claimed is:

1. A document reading apparatus, comprising:
a tray on which a document is placed;
a reading unit configured to read an image of the document;
a reference member;
a control unit configured to determine one reading mode among a plurality of reading modes based on input of an instruction for starting reading, cause the reading unit to read the image of the document placed on the tray in accordance with the one reading mode while conveying the document, and correct data of the image of the document read by the reading unit based on correction data for the one reading mode; and
a setting unit configured to set a plurality of candidate reading modes selected from the plurality of reading modes as candidates for the one reading mode,
wherein the control unit is configured to start generation processing for generating correction data for each of the plurality of candidate reading modes when the setting unit sets the plurality of candidate reading modes.

2. The document reading apparatus according to claim 1, wherein the control unit is configured to, when the setting unit changes the plurality of candidate reading modes after correction data has been generated for each of the plurality of candidate reading modes, start generation of correction data for a candidate reading mode for which correction data has not been generated among the plurality of candidate reading modes after the change.

3. The document reading apparatus according to claim 1, wherein the control unit is configured to start generation processing for generating correction data for each of the plurality of candidate reading modes in a case where the setting unit has set the plurality of candidate reading modes when the document has been placed on the tray.

4. The document reading apparatus according to claim 1, wherein the control unit is configured to generate, in order, correction data for each of the plurality of candidate reading modes in the generation processing, and in a case where the generation processing has not been completed at a timing at which the instruction to start reading has been inputted but generation of correction data for the one reading mode has been completed, end the generation processing.

5. The document reading apparatus according to claim 1, wherein the control unit is configured to generate, in order, correction data for each of the plurality of candidate reading modes in the generation processing, and, in a case where correction data for the one reading mode is being generated at a timing at which the instruction to start reading has been inputted, to end the generation processing when correction data for the one reading mode has been generated.

6. The document reading apparatus according to claim 1, wherein the control unit is configured to generate, in order, correction data for each of the plurality of candidate reading modes in the generation processing, and, in a case where correction data for a reading mode other than the one reading mode among the plurality of candidate reading modes is being generated at a timing at which the instruction to start reading has been inputted and generation of correction data of the one reading mode has not been started, to stop generation of the correction data for the other reading mode and start generation of the correction data for the one reading mode, and to end the generation processing when correction data of the one reading mode has been generated.

7. The document reading apparatus according to claim 1,
further comprising a first storage unit configured to store correction data to be used when the control unit corrects data of the image of the document read by the reading unit, wherein
the control unit is configured to determine, based on a history of the one reading mode, which candidate reading mode's correction data, among the correction data for the plurality of candidate reading modes generated by the generation processing, to store in the first storage unit.

8. The document reading apparatus according to claim 7, wherein the control unit is configured to determine the candidate reading mode for which to store correction data in the first storage unit based on the one reading mode which is determined based on the previous input of the instruction to start reading.

9. The document reading apparatus according to claim 7, wherein the control unit is configured to, based on a number of times that each of the plurality of candidate reading modes has been determined to be the reading mode, determine a candidate reading mode for which to store correction data in the first storage unit.

10. The document reading apparatus according to claim 1, wherein
the plurality of reading modes includes a plurality of first reading modes and a plurality of second reading modes,
the plurality of first reading modes are modes in which the reading unit reads an image of a document in color,
the plurality of second reading modes are modes in which the reading unit reads an image of a document in monochrome, and
the plurality of candidate reading modes includes one first reading mode among the plurality of first reading modes and one second reading mode among the plurality of second reading modes.

11. The document reading apparatus according to claim 10, wherein
the instruction to start reading is any of a first instruction indicating reading in color and a second instruction indicating reading in monochrome, and
the control unit determines the one first reading mode to be the one reading mode when the first instruction is inputted and determines the one second reading mode to be the one reading mode when the second instruction is inputted.

12. The document reading apparatus according to claim 10, wherein
the plurality of first reading modes each have different resolutions at which the document is read by the reading unit, and
the plurality of second reading modes each have different resolutions at which the document is read by the reading unit.

13. The document reading apparatus according to claim 10, wherein the one first reading mode and the one second reading mode are set in response to a setting related to the resolution at which to read the document having being inputted.

14. The document reading apparatus according to claim 1, wherein the correction is a shading correction.
